(19) United States
(12) Patent Application Publication
(10) Pub. No.: US 2003/0200183 A1
(43) Pub. Date: Oct. 23, 2003

(54) Hot spot service system

(76) Inventor: Hidetoshi Sato, Kanagawa (JP)

Correspondence Address: McGuireWoods, Suite 1800, 1750 Tysons Boulevard, Tysons Corner, McLean, VA, 22102-4215, US

(21) Appl. No.: 10/419,945

(22) Filed: Apr. 22, 2003

(30) Foreign Application Priority Data
Apr. 23, 2002 (JP) 120535/2002

(51) Int. Cl. G06F 17/60

(52) U.S. Cl. 705/76

(57) ABSTRACT

A wireless LAN access point 5 is installed in a hot spot belonging to legal person contractor with a service provider, and a data terminal 3 of a user belonging to a legal person contractor in the hot spot receives data by accessing an internet network via the wireless LAN access point 5. When a data terminal 4 as client utilized by a visitor not belonging to any legal person contractor in the hot spot receives desired data by accessing the internet network via the wireless LAN access point, it is connected to a certification server via the internet network, and its connection to the internet network is allowed when and only when it meets a certification condition.

### BACKGROUND OF THE INVENTION

This application claims benefit of Japanese Patent Application No. 2002-120535 filed on Apr. 23, 2002, the contents of which are incorporated by the reference.

The present invention relates to hot spot service systems and, more particularly, to hot spot service systems which can be effectively used in conference rooms of companies or the like for business purposes.

With pronounced development of broadband environment, various services utilizing internet networks are expanding. Among the services, so-called “hot spot service”, which provides internet connection and contents service in such particular places as airports, hotels, coffee rooms and shops, is gradually in practical use. This service is not a public network such as a portable telephone system, but it provides services in very narrow areas. Specifically, internet connection and provision of such contents as motion pictures are made by using a wireless technique called local wireless interface such as wireless LAN and Bluetooth. Unlike the public network such as portable telephone system, the broadband environment is provided by combining wireless LAN of IEEE 802.11 Standard or the like and high rate wired circuit such as ADSL or optical fiber.

In the utilization of such service, internet access is made by using a personal computer in a particular place such as airport, hotel, coffee room or shop, and various services are received via the usual internet system.

However, the prior art hot spot service is provided for general people, and few people carry personal computers for the internet access. That is, visitors are few in number. Therefore, it is difficult to improve the utilization ratio, and also it is difficult to construct a business model.

Another reason for difficulty in building up a business model resides in that it is difficult to preset adequate amounts of money levied to users requiring internet access and users who enjoy the spare time with internet network. For example, when a businessman desires to quickly obtain important data via internet network for making presentation to his or her customer, expensive fee is not a problem. However, when the usual user uses the internet network for enjoyment, which expenditures can not be born at all.

Furthermore, the prior art hot spot service system is such that it is utilized individually by users. Since service versatility increase leads to increase of the utilization fee, a cost problem is posed. For example, with a low utilization fee (for instance 10 yen), the service can not be provided as business at all when demand note production and management expenditures are taken into considerations.

### SUMMARY OF THE INVENTION

An object of the present invention is to provide a hot spot service system, which is suited mainly for business and permits improvement and maintenance of service and appropriate utilization free collection.

According to an aspect of the present invention, there is provided a hot spot service system wherein: a wireless LAN access point is installed in a hot spot belonging to a legal person contractor with a service provider; data is transmitted and/or received with a data terminal of a user belonging to a legal person contractor in the hot spot by accessing an internet network via the wireless LAN access point; and when a data terminal as client utilized by a visitor not belonging to any legal person contractor in the hot spot transmits and/or receives data via the wireless LAN access point, it is connected to a certification server via the internet network, and its connection to the internet network is allowed when and only when it meets a certification condition.

When a data terminal of the user belonging to the legal person contractor transmits and/or receives data by accessing the internet network via the wireless LAN access point, it is connected to the certification server via the internet network, and it is connected to the internet network when and only when it meets the certification condition. The hot spot service system according to one of claims 1 and 2, wherein the wireless LAN access point makes a check, with reference to the recognition No. of the user's data terminal, as to whether the data terminal is a client presently in internet service and, if not so, makes a check, by transmitting data inputted by the user and including ID No. and password to the certification server via the internet network, as to whether the data terminal is a hot spot service subscriber, when the certification server provides a certification, it transmits a utilization allowance signal to the wireless LAN access point via the wireless internet network, and when the wireless LAN access point receives the utilization allowance signal, it subsequently makes transmission and/or reception of data having identity with the machine recognition No. of the user's data terminal.

The certification is made under a condition that the visitor is a member of the provider of the present service or a member of a joint internet service provider and an option contractor of the present hot spot service. As for the price of the utilization of the hot spot service system, discount fees are preset for users meeting a particular condition. The price of the utilization of the hot spot service system is all paid by the legal person contractor.

The hot spot is a meeting room, a conference room or a meeting corner. The data terminal is a personal computer or a personal assistant. The user belonging to the legal person contractor does E mail transmission/reception after receiving the certification. The joint internet service provider and the hot service provider register the contractor in the certification server when the hot spot service option contract is made.

The price of the utilization is demanded via the hot spot service provider or the joint internet service provider. The legal person announces that the hot spot service is now provided. The legal person contractor receives a benefit corresponding to sales from hot spot service provider for its provision of business area as the hot spot. The data terminal displays advertisement data.

Other objects and features will be clarified from the following description with reference to attached drawings.

### BRIEF DESCRIPTION OF THE DRAWINGS

FIG. 1 is a view illustrating a first embodiment of the hot spot service system according to the present invention; and

FIG. 2 is an example of log-in frame on the display according to the embodiment of the present invention.

### PREFERRED EMBODIMENTS OF THE INVENTION

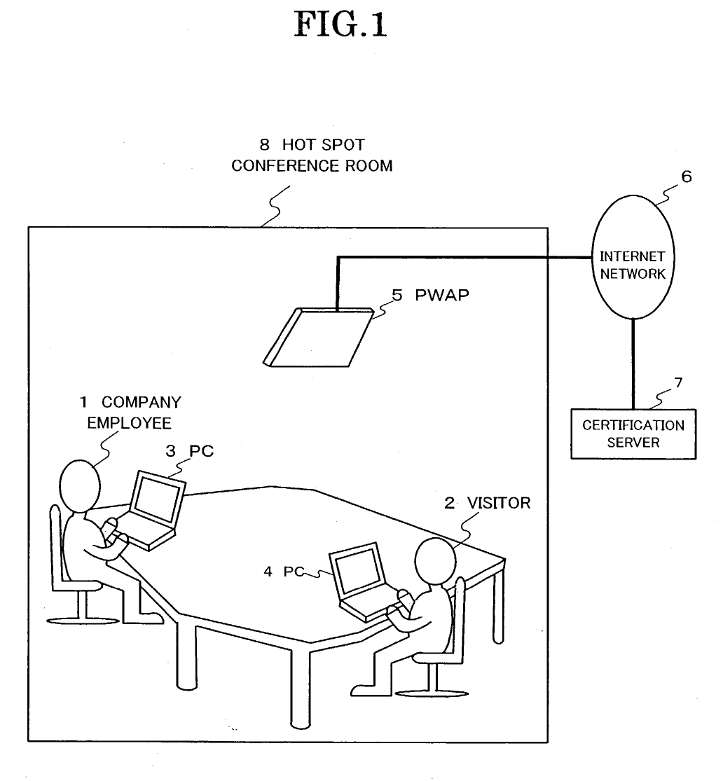

Preferred embodiments of the present invention will now be described with reference to the drawings. FIG. 1 is a view illustrating a first embodiment of the hot spot service system according to the present invention.

In this embodiment, legal person (cooperation) contrasts of ISP (internet service provider) are assumed with, for instance, a conference room or a meeting room in a project restricted as the subject of hot spot to the business purpose. In this way, pronounced effects such as improvement and maintenance of service, collection of appropriate utilization fee for business, improvement of service to visitors and improvement of the project image.

In the embodiment it is noted that the internet access need is increasing in meeting rooms, conference rooms and meeting corners for business prearrangements, and places of meeting visitors, such as a meeting room, a conference room or a meeting corner in a project is made to be a hot spot for providing hot spot service. For example, a meeting room or a conference room or a meeting corner in a project is set as service area, in which a wireless LAN access point for the hot spot service is installed to provide service of connecting a visitor or a company employee therein to internet network via the wireless LAN access point. The hot spot service includes such rich contents as music and motion pictures suited for high rate communication.

Referring to FIG. 1, a company employee 1 and a visitor 2 are making a conference in a conference room 8. An internet connection is provided by wireless LAN communication via a hot spot service wireless LAN access point (PWAP) 6.

More specifically, a PWAP 5 is installed in the conference room at a predetermined position therefor. The visitor 2 accesses an internet network 6 via the PWAP 5 by using his or her own personal computer 4. The access by the visitor 2 is coupled to a certification server 7 via the internet network 8 to obtain certification.

At this time, the visitor 2 is to obtain a certification under a condition that he or she is a member of this service provider or a member of a joint internet service provider (ISP) and also an option contractor of the hot spot service, and when the certification condition is met, the internet connection is effected. As for the price for utilization, a fixed amount per month is paid. In the case of a member of the instant service provider, the price levying from the member is made by a payment method directly based on the contract. In the case of a joint ISP member, the utilization fee is levied by the joint ISP company.

Likewise, the company employee 1 shown in FIG. 1 uses the contract of the own contracted service provider for receiving the internet service and pay the price. In this case, it may be made to be possible to obtain a discount service under a condition that the company employee 1 is a member of the equipment installation company or under a condition that the equipment installation company member uses the system in the own company.

By introducing the hot spot service according to the present invention in a project, it is possible to improve the visitor service to the project and also provide adequate service to the company employee, thus increasing the social evaluation of the project and leading to efficiency increase of the conference, so that the project can bear part or full maintenance cost such as the fee of use of line and maintenance service cost. Also, in a sense of providing the place of service, it is possible to receive payment of the price corresponding to service sales.

The construction and operation of the embodiment will now be described with reference to FIG. 1.

The conference room 8, which can provide wireless LAN communication via the PWAP 5 is made to be a hot spot, and the company employee 1 with the personal computer 3 and the visitor 2 with the personal computer 4 are made to be users. The personal computers 3 and 4 having wireless LAN client functions are connected as clients to the internet network 6 and the certification server 7. The personal computers 3 and 4 are data processing units to serve personal computer, personal data assistant, etc.

For security setting, three items, i.e., SS-ID (or ESS-ID), WEP and Mac address, are mainly utilized. The SS-ID (Service Set ID) is of such type as to permit mutual communication of access points having the same ID and also to prevent access from units having different IDs. The ESS-ID (Enhanced Service Set ID) has an additional roaming function that it can freely move among a plurality of APs. The WEP (Wired Equivalent Privacy) encipher inter-wireless-section data in an enciphering system called RC-4 using a key length of 40 bits. The Mac (Media Access Control) address is a number peculiar to the unit, which is assigned not only to each wireless LAN product but also to each wired LAN product.

It is now considered a state that the company employee 1 and the visitor 2 are present in a conference in the conference room 8 providing wireless LAN communication with the PWAP 5. In the conference, the visitor 2, intending to explain a product, accesses the internet network 6 by using the personal computer 4, then opens a home page of the own company, and explains the product to the company employee 1 with reference to the displayed contents. The company employ 1, intending to report the contents of the conference to his or her supervisor and receive an instruction therefrom, accesses the internet network 7 by using the personal computer 4, and utilizes E mail.

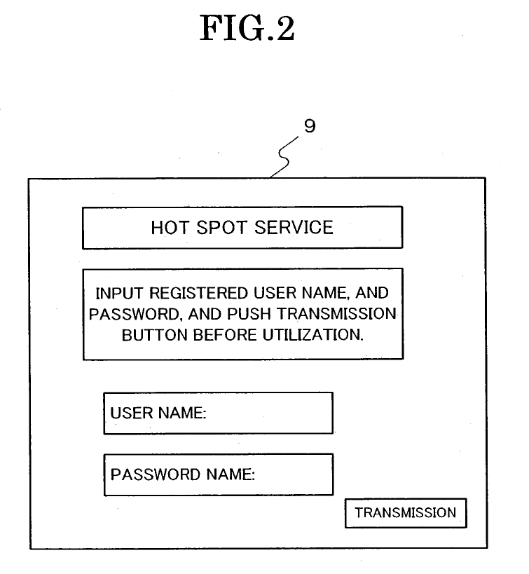

At this time, the visitor 2 makes WEB access by using the own personal computer 4. However, a wireless LAN client accommodated in the personal computer 4 accesses the PWAP 5 with wireless LAN, and accesses a URL designated by the visitor 2. The PWAP 5 checks whether the designated URL is a client in the present internet service with reference to the recognition number (usually MAC address). When the check yields “NO”, the PWAP has to check whether the URL is a hot spot service subscriber. To this end, the PWAP 5 starts a WEB server function, and transmits a log-in frame 9 as shown in FIG. 2 to the personal computer 4 independently of the designated URL.

The visitor 2 inputs and transmits the user name (i.e., ID number) and password as shown in the log-in frame 9. The PWAP 5 shown in FIG. 1 transmits the data to the certification server 7 via the internet network 6.

The certification server 7 now refers to the own possessed user data, and when a pertinent contractor is present and the password is identical, it transmits a utilization permission signal to the PWAP 5 via the internet network 6. The PWAP 5 receiving the utilization permission signal directly transmits the data which is identical with a machine recognition number of the personal computer 4.

After the above process, the personal computer 4 freely accesses the internet network 6 for causing the display of the WEB of the company of the visitor 2 on the display screen of the personal computer 4.

The company employee 1, likewise, accesses the WEB, and after receiving the certification it starts E Mail for data transmission and reception to report the conference contents to his or her supervisor and receive an instruction therefrom.

When the company employee 1 and the visitor 2 have preliminarily contracted with a hot spot service provider (HSP) or have entered into a hot spot option contract in addition to a previously made contract with the hot spot joint ISP, they are registered to the certification server shown in FIG. 1 for utilization by paying a monthly contract fee (or it may be allowed to pay the fee later), and the registration contents are maintained by the continuation of the contract.

The joint ISP and the hot spot provider are organized such that when a hot spot service option contract has been entered into, the contractor is registered in the certification server 7 in FIG. 1.

In case where the company employee 1 is a legal person contractor of the HSP and the visitor 2 is a legal person contractor of the joint ISP, as for the fee of utilization by the company employee the HSP demands the hot spot utilization fee to the company of the company employee, and receives payment. As for the utilization of the visitor 2, the HSP demands the hot spot service utilization fee to the joint ISP, with which the visitor is subscribed. The joint ISP demands the basic contract fee of the visitor 2 and the hot spot service option utilization fee to the legal payer in the legal person contractor with the visitor 2, and receives payment.

The project having the hot spot conference room 8 can announce that “hot spot service is now available” for the purpose of advertisement of the own company. The HSP bears service maintenance expenditures because of the fact that company introduction with hot spot data capable of being utilized, as independently informed to the customer by it, is helpful for improving the project image, and leads to improvement of service to important customers.

It is further possible to cause display of advertisement data on the display screen of a personal computer in internet connection via the provider and levy advertisement fee. In this case, the user of the instant service is specified (mainly project), so that the advertisement content subject may concern only advertisement effective to the user. The instant service thus can be very efficient advertisement medium.

It is possible that the company having the hot spot conference room 8 pays the communication fees of the visitor and the company employee to the HSP. It is further possible that a hot spot providing a business area to the HSP, receives a benefit corresponding to the sales from the HSP.

As has been described in the foregoing, with the hot spot service system according to the present invention the following pronounced advantages are obtainable. Since the hot spot service system is for providing service in conference rooms in projects and has an aim of being used basically for business, it can be utilized as additional option of legal person contracts, which company employees or projects have already entered into with the ISP, and can be readily subscribed with.

Moreover, such pronounced advantages are obtainable that the users can be specified, that since many businessmen have contacts with a plurality of companies with the aim of transactions, it is possible to utilize the internet network so long as the project to be visited to is a project or an office which has already introduced the instant hot spot service, and that the service has the aim of being used for business, it is possible to increase subscribers even with slightly high fee of utilization.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A hot spot service system wherein:
a wireless LAN access point is installed in a hot spot belonging to a legal person contractor with a service provider;
data is transmitted and/or received with a data terminal of a user belonging to a legal person contractor in the hot spot by accessing an internet network via the wireless LAN access point; and
when a data terminal as client utilized by a visitor not belonging to any legal person contractor in the hot spot transmits and/or receives data via the wireless LAN access point, it is connected to a certification server via the internet network, and its connection to the internet network is allowed when and only when it meets a certification condition.

2. The hot spot service system according to claim 1, wherein when a data terminal of the user belonging to the legal person contractor transmits and/or receives data by accessing the internet network via the wireless LAN access point, it is connected to the certification server via the internet network, and it is connected to the internet network when and only when it meets the certification condition.

3. The hot spot service system according to claim 1, wherein the wireless LAN access point makes a check, with reference to the recognition No. of the user's data terminal, as to whether the data terminal is a client presently in internet service and, if not so, makes a check, by transmitting data inputted by the user and including ID No. and password to the certification server via the internet network, as to whether the data terminal is a hot spot service subscribers when the certification server provides a certification, it transmits a utilization allowance signal to the wireless LAN access point via the wireless internet network, and when the wireless LAN access point receives the utilization allowance signal, it subsequently makes transmission and/or reception of data having identity with the machine recognition No. of the user's data terminal.

4. The hot spot service system according to claim 1, wherein the certification is made under a condition that the visitor is a member of the provider of the present service or a member of a joint internet service provider and an option contractor of the present hot spot service.

5. The hot spot service system according to claim 1, wherein as for the price of the utilization of the hot spot service system, discount fees are preset for users meeting a particular condition.

6. The hot spot service system according to claim 1, wherein the price of the utilization of the hot spot service system is all paid by the legal person contractor.

7. The hot spot service system according to claim 1, wherein the hot spot is a meeting room, a conference room or a meeting corner.

8. The hot spot service system according to claim 1, wherein the data terminal is a personal computer or a personal assistant.

9. The hot spot service system according to claim 1, wherein the user belonging to the legal person contractor does E mail transmission/reception after receiving the certification.

10. The hot spot service system according to claim 1, wherein the joint internet service provider and the hot service provider register the contractor in the certification server when the hot spot service option contract is made.

11. The hot spot service system according to claim 1, wherein the price of the utilization is demanded via the hot spot service provider or the joint internet service provider.

12. The hot spot service provider according to claim 1, wherein the legal person announces that the hot spot service is now provided.

13. The hot spot service system according to claim 1, wherein the legal person contractor receives a benefit corresponding to sales from hot spot service provider for its provision of business area as the hot spot.

14. The hot spot service system according to claim 1, wherein the data terminal displays advertisement data's
